(19) United States
(12) Patent Application Publication
(10) Pub. No.: US 2022/0126682 A1
(43) Pub. Date: Apr. 28, 2022

(54) SANDWICH MOTORIZED VEHICLE TANK WITH EVERTED BARRIER FOIL AND THEREON AT LEAST LOCALLY INJECTED THERMOPLASTIC MATERIAL

(71) Applicant: Röchling Automotive SE & Co. KG, Mannheim (DE)

(72) Inventors: Dieter Kerschbaumer, Tramin (IT); Petru-Sorin Muj, Bolzano (IT); Ivan De Metri, Bolzano (IT)

(73) Assignee: Röchling Automotive SE & Co. KG

(21) Appl. No.: 17/496,116

(22) Filed: Oct. 7, 2021

(30) Foreign Application Priority Data
Oct. 23, 2020 (DE) 10 2020 128 012.2

(51) Int. Cl. B60K 15/03

(52) U.S. Cl. CPC B60K 15/03177; B60K 2015/03046; B60K 2015/03453; B60K 2015/03493; B60K 2015/03065

(57) ABSTRACT

A motorized vehicle tank, having a first tank shell and a second tank shell, where the first tank shell and the second tank shell between them define at least one section of a tank volume of the motorized vehicle tank, where the first tank shell and the second tank shell are connected with each other, where at least one tank shell out of the first and the second tank shell is a multicomponent tank shell which exhibits a barrier foil and at least area-wise an inner wall section injected by injection-molding onto the internal side of the barrier foil facing towards the tank volume and/or an outer wall section injected by injection-molding onto the external side of the barrier foil facing away from the tank volume; the motorized vehicle tank exhibits in at least one tank wall section formed from the multicomponent tank shell an eversion formed integrally at the barrier foil, which projects relative to the tank wall region surrounding it.

This application claims priority in German Patent Application DE 10 2020 128 012.2 filed on Oct. 23, 2020, which is incorporated by reference herein.

The present invention concerns a motorized vehicle tank, comprising a first tank shell and a second tank shell, where the first tank shell and the second tank shell between them define at least one section of a tank volume of the motorized vehicle tank, where the first tank shell and the second tank shell are connected with each other, where at least one tank shell out of the first and the second tank shell is a multicomponent tank shell which exhibits a barrier foil and at least area-wise an inner wall section applied by injection molding to the internal side of the barrier foil facing towards the tank volume and/or an outer wall section applied by injection molding to the external side of the barrier foil facing away from the tank volume.

### BACKGROUND OF THE INVENTION

Such a motorized vehicle tank is known from DE 10 2017 119 706 A1. The tank shells of the known motorized vehicle tank are a top shell and a bottom shell, which together bound the entire tank volume. Both tank shells exhibit a barrier foil to prevent outward migration of chemicals from the tank volume through the tank shells, which can be reinforced on both sides, i.e. inside and outside, with material applied by injection molding. For certain chemicals, such as for instance hydrocarbons diffusing out of fuel, the injection-molded material alone does not offer a sufficient migration barrier. The barrier foil alone does not provide sufficient durable stability and can be attacked by external effects.

A further motorized vehicle tank is known from DE 10 2017 119 708 A1, in which the tank's top shell and the tank's bottom shell are each formed from a barrier foil reinforced only on one side with injection-molded material. Here the barrier foil is located on the tank's bottom shell on the internal side facing towards the tank volume, such that the outer wall injected outside the barrier foil can protect the barrier foil against stone impact etc. At the tank's top shell of the known motorized vehicle tank, unlike the tank's bottom shell, add-on parts and form elements can be installed at the injected inner wall, in particular welded on, without therefor having to disturb the barrier foil.

A further motorized vehicle tank is known from DE 10 2016 214 059 A1, which exhibits a sandwich structure made from an injection-molded inner wall, an injection-molded outer wall, and an injection-molded barrier layer arranged between the inner and outer wall in the thickness direction. The tank shells of this fuel tank are formed by means of a multicomponent injection molding process.

The multicomponent injection molding process for forming a barrier layer between the injection-molded inner and outer layer is difficult to control as regards the layer thicknesses and layer thickness distribution that is to be maintained along the tank shell's surface.

A tank shell with a completely exposed barrier foil harbors an elevated risk of damaging the barrier foil.

Normally, using a barrier foil on a multicomponent tank shell restricts further processing of the tank's shell, since as far as possible any risk of damaging the barrier foil should be excluded, as any damage to the barrier foil would thwart the purpose of its use.

### SUMMARY OF THE INVENTION

It is, therefore, the task of the present invention to offer a technical solution, according to which the motorized vehicle tank mentioned at the beginning, despite using a multicomponent tank shell, can be used extensively in a motorized vehicle.

This task is solved by the present invention quite generally by means of a motorized vehicle tank of the type mentioned at the beginning, in which at least one tank wall section formed by the multicomponent tank shell exhibits an eversion formed integrally at the barrier foil, said eversion projecting from the tank wall region surrounding it.

The barrier foil, preformed in a predefined shape, is installed and/or incorporated respectively into the multicomponent tank shell. The barrier foil is preferably made from a thermoplastic material and can as such be formed thermally in the predefined shape, before then injection-molding material is injection onto at least one of its exposed surfaces. It should, however, not be excluded that the barrier foil comprises or is a thermosetting material, which is preformed in the predefined shape and is then cured in this shape.

The barrier foil of the at least one tank shell is preferably dimensionally stable, i.e. it retains its shape under the effect of its own weight.

The eversion in the barrier foil, which leaves the barrier foil completely intact, can exhibit numerous different tasks, as shall be elucidated hereinunder.

According to a general, simple, but very effective embodiment, the eversion can be used as an enlargement of the tank volume, if outside the same tank wall section but conceived notionally as non-everted there is available installation space in the motorized vehicle, which without eversion remains unutilized as dead space in the vehicle. For this use, logically the eversion will project outward away from the tank volume relative to the non-everted tank wall section surrounding it.

In the opposite direction, the eversion can be used as a reduction of the tank volume, if the tank wall section conceived notionally as non-everted were to foul a component of the motorized vehicle. Thus through the eversion inwards towards the tank volume, the installability of the motorized vehicle tank in a motorized vehicle can be made certain.

Although in the present case it would suffice if only one tank shell of the motorized vehicle tank is configured as a multicomponent tank shell, for the most extensive prevention possible of undesirable diffusion processes of contents from the tank volume of the motorized vehicle tank, preferably both aforementioned tank shells are multicomponent tank shells.

Furthermore it should not be ruled out that the motorized vehicle tank exhibits more than only the two aforementioned tank shells, although a motorized vehicle tank whose tank casing is formed only from the two aforementioned tank shells is preferable because of the associated low production and fabrication cost. Preferably, all tank shells of the motorized vehicle tank are multicomponent tank shells.

In principle, for mere enlargement of the tank volume or for preventing fouling of a vehicle component located outside the motorized vehicle tank, the tank wall section forming the eversion can be formed solely by the barrier foil.

The eversion can moreover serve as a manipulation formation, with which or in which a manipulation tool can engage.

For mechanical and physical reinforcement of the tank wall section forming the eversion, the eversion can exhibit on at least one side out of its internal side facing towards the tank volume and external side facing away from the tank volume an injected wall section out of injected inner wall section and/or injected outer wall section, respectively.

The eversion exhibits a concave and a convex side. If the eversion is everted away from the observer, the latter looks on its concave side. If the eversion is everted towards the observer, the latter looks on its convex side. Preferably, the eversion can at least on its convex side exhibit the injected wall section. The convex side, which is better accessible from its immediate surroundings than the concave side bounded by the tank wall section itself surrounding the eversion, is especially useful because of this accessibility for realizing further functions.

Since the concave side of the eversion can be used especially simply as a centering formation, in order to protect the concave side of the eversion from the tool impact of a manipulation tool, which also includes a centering tool, the concave side of the eversion can be provided with an injected wall section made from an injection-molded material.

For example, a functional formation that is different from the bare eversion can be connected with the injected wall section. This applies in particular to the convex side of the eversion. Such a functional formation can be a mounting formation, such as a mounting lug or a mounting projection including a mounting hook, with which the motorized vehicle tank can be attached, in the region of the tank wall section forming the eversion, to an external structure, for instance a section of a motorized vehicle body. Since usually the tank is mounted by its external side on supporting structures, this concerns essentially an eversion everted away from the tank volume.

Likewise the functional formation can be a tie rod section of a tie rod configured inside the tank. Then the eversion is preferably everted in the direction towards the tank volume.

Preferably the functional formation is produced in the same injection-molding step in which the wall section injected onto the barrier foil is also produced.

The configuration of a tie rod inside the tank is especially relevant, since such a tie rod helps to prevent the motorized vehicle tank, which normally is not especially thick-walled, deforming due to the pressure differences between the pressure in the tank volume and the pressure of the external environment that may possibly arise during operation. Therefore, according to an especially preferred embodiment of the present invention, the motorized vehicle tank can exhibit tank wall regions lying opposite each other across the tank volume which are connected with each other physically by means of at least one tie rod, where on at least one tank shell a tie rod base comprises the eversion as a recess projecting on the tank's internal side towards the tank volume, from which a tie rod section projects into the tank volume.

Preferably, the tie rod section is configured integrally with an inner wall section injected onto the eversion, especially preferably in a single injection molding shot. A surface of the eversion exposed towards the tank volume, preferably a flat surface, can however also be used as an assembly surface for fitting a tie rod component as the tie rod section by means of mounting, for instance by gluing.

Although it can suffice if only exactly one of the tank shells, which exhibit tank margin regions connected with each other through the tie rod, exhibits a tie rod base with the aforementioned recess, it is preferable that each of the tank shells as a tie rod base of one and the same tie rod exhibits one recess projecting towards the tank volume. From each of the recesses, then, one tie rod section can then project from each of the recesses into the tank volume, with the tie rod sections projecting from the two recesses being connected with each other in a tensile force-transmitting manner.

The at least one recess as tie rod base can have an advantageous effect in several respects. For one thing, the tie rod sections can be configured as shorter than without the at least one recess, since the distance to be surmounted by the tie rod beyond the tank volume is shortened by the overhang dimension of the at least one recess. As a result, the tie rod itself and thus the tie rod sections forming it, which protrude from the at least one recess, can be demolded undamaged with greater reliability from the injection mold producing them. Moreover, as mentioned above, the at least one recess can be engaged on its side facing away from the tie rod section for alignment of the tie rod sections by a manipulation tool during production of the tensile force-transmitting connection of the tie rod sections projecting towards each other from different tank shells. The tie rod section is preferably attached at the recess on its convex side and projects away from it.

The tie rod sections projecting from the two recesses can be connected with each other, for instance glued, welded, and/or clipped together at their end regions located remotely from their respective recess. Preferably, a mirror welding process is used when welding the end regions, in particular end faces of the respective tie rod sections facing towards each other. Advantageously, the two tank shells are themselves also joined to each other in the welding step in which the tie rod sections of different tank shells proceeding towards each other are welded together. For such welding and/or clipping, the engagement of the respective recess of a tie rod base by a manipulation tool for aligning the two tie rod sections and in particular their surfaces being joined together is also advantageous.

Mirror welding is a preferred welding technology. It is, however, also possible to join the tank shells together with other welding methods, for instance hot gas, infrared, ultrasound, or friction welding methods.

The tie rod sections of a tie rod proceeding towards each other from different tank shells can exhibit different shapes on the two sides of their attachment point. It is preferable, however, that the tie rod sections of a tie rod exhibit the same shape on the two sides of their attachment point, in order to have at the attachment point matching opposing attachment surfaces which can be joined together into a tie rod.

In order to prevent needless damage to the tank in the event of collisions sustained by the motorized vehicle carrying the motorized vehicle tank, at least one tie rod section can exhibit a predetermined failure formation which is configured to fail when a predetermined load exceeds a predetermined threshold value. The predetermined failure formation can preferably be produced very accurately in the injection molding process in which the tie rod section is produced. It can be a thin point in the material at which the tie rod tears or breaks when a threshold value for the tensile stressing of the tie rod is exceeded. Alternatively or additionally, it can be a thin point in the material at which the tie rod is deformed, in particular buckles, when a threshold value of a bending moment acting on the tie rod is exceeded.

The aforementioned clipping together as an attachment of the two tie rod sections of the different tank shells proceeding towards each other can also be a predetermined failure formation in the above sense. The clipping together can be such that it fails when a predetermined tensile stressing of the tie rod is exceeded and/or when a predetermined bending stress of the tie rod is exceeded and it separates the initially connected tie rod sections.

To avoid superfluous weight, at least one tie rod section is configured as hollow, or preferably both tie rod sections associated with the same tie rod and starting from different tie rod bases with recesses are configured as hollow. To avoid unnecessary volume loss in the tank volume, one wall of the tie rod section can exhibit at least one breach penetrating through the wall, preferably a plurality of breaches, which connect a region of the tank volume located outside the tie rod section with a tie rod inner volume located inside the tie rod section in a fluid-mechanically communicating manner.

Preferably, at least one penetrating breach is located nearer by the tie rod base located in the ready-to-operate assembled motorized vehicle tank in the direction of the gravitational effect further down, such that the hollow space of the tie rod and/or of the tie rod section respectively can be emptied again.

Alternatively to the aforementioned recess, the eversion can be a bulge protruding on the tank's external side away from the tank volume. On such a bulge, the mounting formation described above, i.e. a mounting lug and/or mounting projection, can for example be configured.

As a further design option, the bulge can be a connecting piece blank, which is configured for connecting a hose or pipe. The connecting piece blank is initially closed off, i.e. the tank volume is not accessible through it from the outside due to the intact deformed barrier foil. However, the longitudinal end of the connecting piece blank projecting from the tank's wall can be drilled out or cut off and thereby the connecting piece blank activated and made into a connecting piece. Thus one and the same tank can be delivered with a preparation for connection to different vehicle manufacturers, which depending on their needs either utilize the connecting piece blank or leave it unmodified on the tank. The connecting piece blank thus forms an option for connecting a fluid line to the tank, without the integrity of the migration barrier having to be impaired for providing this option.

The eversion can be dome-shaped, or frustoconical, or conical, or a combination of such shapes. For example, the eversion can at its region located nearer to the tank's wall section be configured in a frustoconical shape, where a dome-shaped or, as described above as an assembly surface, a flat region can adjoin the end of the frustoconical region located remotely from the tank wall section. The eversion can exhibit an enveloping surface section that it tilted relative to the tank wall region surrounding it. Preferably this enveloping surface section is closed and runs around an eversion axis, along which the eversion is everted from the tank wall section.

If the eversion is part of a tie rod that proceeds along a tie rod axis between the tank wall sections which it connects, normally the tie rod axis is the eversion axis and vice versa.

In order to increase the connection strength between the injected wall section and the eversion, the enveloping surface section can project along the eversion axis relative to the tank wall region surrounding the eversion and exhibit at least one rear-gripping profile. The rear-gripping profile can exhibit in longitudinal section, for example in a longitudinal section containing the eversion axis, a wavy, and/or sawtooth, and/or zigzag shape. The rear-gripping profile can be configured just in circumferential sections of the enveloping surface section, or preferably run completely around the eversion axis in order to provide the largest possible effective area with the enveloping surface section.

In principle, the eversion can be conceived as exhibiting an aperture through which the tank volume is accessible from the tank's external environment. However, for the aforementioned reasons of maximizing the undamaged integrity of the barrier foil and thus of the migration barrier, this is not preferred. Therefore, the eversion can exhibit a cover section as already suggested above that spans the enveloping surface section, where the enveloping surface section is located between the tank wall region surrounding the eversion and the cover section. Preferably, the cover section is less strongly tilted than the enveloping surface section relative to the tank wall section surrounding the eversion section. The cover section can be configured as flat, for example in order to provide an assembly surface, or it can be configured as curved, for example dome-shaped.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 A perspective longitudinal section through a first embodiment of the invention of a motorized vehicle tank,

FIG. 2 The motorized vehicle tank of FIG. 1 in a vertical longitudinal section,

FIG. 3 A second embodiment of a tie rod inside the motorized vehicle tank,

FIG. 4 A third embodiment of a tie rod inside the motorized vehicle tank,

FIG. 5A A detailed longitudinal section of a joint site of the tank shells forming the motorized vehicle tank of FIG. 1 in readiness position before making the joint,

FIG. 5B A longitudinal section of the joint site of FIG. 5A after making the joint,

FIG. 5C A longitudinal section of the joint site of FIG. 5B after flush separation of the joined barrier foils at the end faces of the joint flange,

FIG. 6 A longitudinal section of a joint site of a second embodiment of the invention of a motorized vehicle tank with a different shape of the joint,

FIG. 7 A longitudinal section of a joint site of a third embodiment of the invention of a motorized vehicle tank with a different shape of the joint, and

FIG. 8 A longitudinal section of a joint site of a fourth embodiment of the invention of a motorized vehicle tank with a different shape of the joint.

### DESCRIPTION OF PREFERRED EMBODIMENTS

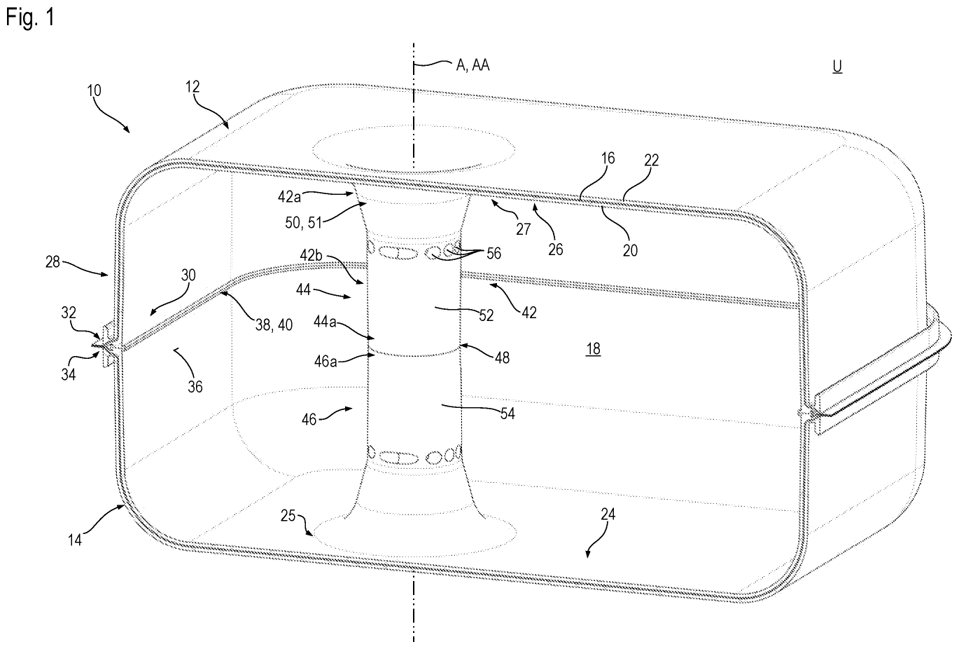

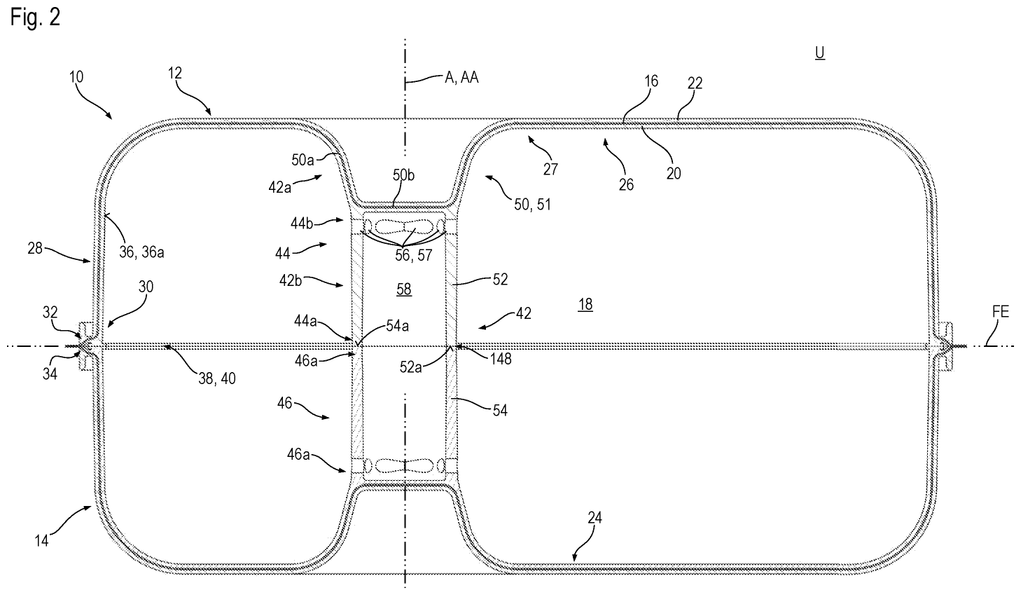

Referring now to the drawings wherein the showings are for the purpose of illustrating preferred and alternative embodiments of the invention only and not for the purpose of limiting the same, in FIGS. 1 and 2, a first embodiment of the invention of a motorized vehicle tank is depicted in rough schematic form in a perspective section (FIG. 1) and in a vertical longitudinal section (FIG. 2) and denoted generally by 10. The motorized vehicle tank 10, which preferably is a gasoline tank, comprises a tank top shell 12 as a first tank shell and a tank bottom shell 14 as a second tank shell.

The tank top shell 12 and the tank bottom shell 14 are each three-layered, comprising a middle barrier foil 16, an inner wall 20 applied to the barrier foil 16 by injection molding towards the tank volume 18, and an outer wall 22 applied to the barrier foil 16 by injection molding on the side facing away from the tank volume 18 and facing towards the tank's external environment U.

The tank's top shell 12 and the tank's bottom shell 14 are joined with each other by mirror welding along a common joint plane FE. The tank shells depicted in the drawings, tank top shell 12 and tank bottom shell 14, are configured mirror-symmetrically relative to the joint plane FE at least in the depicted segments, which is why as regards the described mirror symmetry, the description of just the tank top shell 12 also serves as a description of the tank bottom shell 14.

In fact, the tank top shell 12 and the tank bottom shell 14 do not have to be configured mirror-symmetrically or not completely so, and normally indeed are not, since for example at least one functional module can be arranged in the tank's top shell 12, in the region of a tank ceiling 26, which serves for the extraction of fluid accommodated in the tank 10, in particular gasoline fuel, and/or for ascertaining the fluid level in the tank 10.

Hereinafter, therefore, only the tank top shell 12 will be described as representing both tank shells 12 and 14.

The tank top shell 12 exhibits the tank ceiling 26, which lies opposite a tank floor 24 diametrically across the tank volume 18. Statements that with respect to the tank top shell 12 concern the tank ceiling 26 or that refer to the tank ceiling 26, also apply to the tank's bottom shell 14 with the proviso that they concern the tank floor 24 and/or refer to the tank floor 24 respectively based on the aforementioned mirror-symmetry condition.

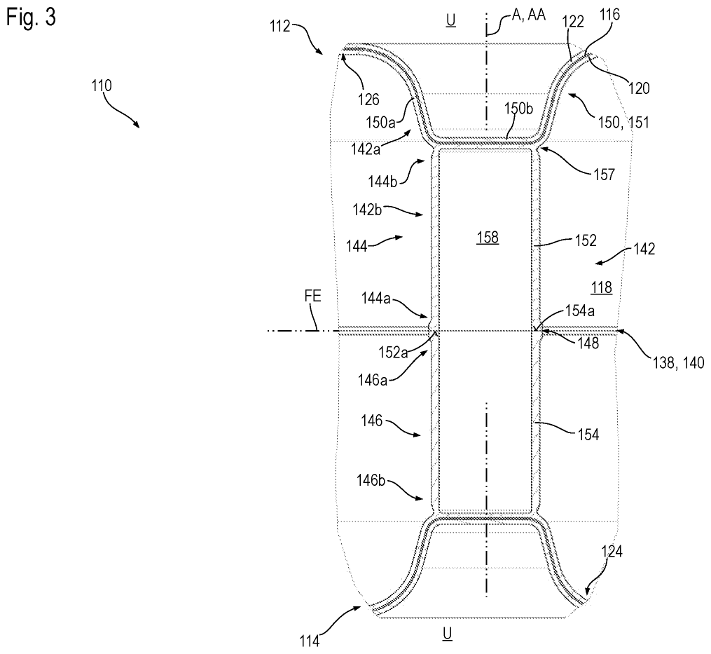

From the tank ceiling 26, there extends towards the tank's bottom shell 14 an encircling side wall section 28, connected integrally with the tank ceiling 26. The side wall section 28 exhibits at its marginal region 30 that is remote from the tank ceiling 26 a completely closed joint flange 32 encircling the tank volume 18. The joint flange 32 of the tank top shell 12 is firmly bonded with the joint flange 34 of the tank bottom shell 14, preferably by means of the mirror welding process already mentioned above. A welding bead 38 produced by means of the mirror welding process on the tank's internal side 36 indicates the course of the joint 40 between the tank's top shell 12 and the tank's bottom shell 14. The joint 40 will be described below in further detail in connection with FIGS. 3 to 5, in which the joint flanges 32 and 34 that are joined with each other are shown enlarged.

For example, due to fuel vapors forming in the tank volume 18 of the motorized vehicle tank 10, the pressure prevailing in the tank volume 18 can change quantitatively considerably in the course of the operation of the motorized vehicle tank 10. This occurs in particular in plug-in hybrids, in which the internal combustion engine can remain turned off over an extended period during the travel operation. In the external environment U of the tank 10 there normally always prevail ambient conditions, i.e. atmospheric pressure of the order of magnitude of about 1000 hPa.

In order to prevent deformation of the tank shells 12 and 14 due to pressure differences between an elevated pressure in the tank volume 18 and a quantitatively lower pressure relative to it in the external environment U of the tank, there are configured at the tank shells 12 and 14 tie rods 42 which extend between the tank's ceiling 26 and the tank's floor 24 or generally between opposite tank wall sections 25 and 27.

Such a tie rod 42 is formed in the present example by a tie rod top part 44 and a tie rod bottom part 46. For the sake of simplicity, in the present example the tie rod top part 44 and the tie rod bottom part 46 are configured as mirror-symmetrical relative to the joint plane FE as the plane of mirror-symmetry. Once again, therefore, it suffices to describe only one formation made of tie rod top part 44 and tie rod bottom part 46. The description also applies to the other formation respectively, subject to the aforementioned symmetry condition.

In the depicted embodiment example, the tie rod top part 44 and the tie rod bottom part 46 are configured as essentially rotation-symmetrical relative to a tie rod axis A orthogonal to the joint plane FE. The tie rod axis A is also an eversion axis AA, along which the eversion 51 is everted relative to the tank wall region 27 surrounding it. In the present case the eversion 51 is rotation-symmetrical relative to the eversion axis AA. This need not be the case: the tie rod 42 and/or the eversion 51 can respectively, instead of a rotation-symmetrical configuration, also be formed in polyhedral shape or be irregularly marginated or can be formed in a framework manner through struts.

The tie rod top part 44 and the tie rod bottom part 46 are firmly bonded with each other at their longitudinal end regions 44a and 46a respectively that face towards each other. Preferably, the firm bonding of tie rod top part 44 and bottom part 46 is produced in the same mirror welding procedure in which the joint flanges 32 and 34 are also connected with each other. Therefore preferably the joint 48 of the tie rod top part 44 and the tie rod bottom part 46 also lies in the joint plane FE.

FIG. 2 shows the motorized vehicle tank 10 in rough schematic form in a vertical longitudinal section, where the joint plane FE is oriented orthogonally to the drawing plane of FIG. 2. The sectional plane of FIG. 2 contains the tie rod axis A.

In the region of a tie rod base 42a of the tie rod top part 44, the barrier foil 16 is depressed in a direction towards the tank volume 18, i.e. in a direction towards the joint flange 32 and/or towards the joint plane FE of the tank top shell 12 that carries the tie rod top part 44, respectively, as an eversion 51 forming a recess 50. The recess 50 of the barrier foil 16, which advantageously tapers towards the joint plane FE, was configured thermally by reshaping before the injection of the tank's inner wall 20 and the tank's outer wall 22 onto the barrier foil 16.

The barrier foil 16, before being placed in an injection mold, is reshaped into its shape as shown essentially in FIGS. 1 and 2 and maintains it. The barrier foil 16 is therefore dimensionally stable, i.e. under the effect of its own weight it essentially retains its shape and is not deformed plastically.

The recess 50 of the barrier foil 16 is formed by an envelope section 50a that tapers towards the joint plane FE and by a preferably flat cover section 50b that spans the envelope section 50a. The recess 50, which is connected integrally with the rest of the barrier foil 16, is uninterrupted and thus forms also in the region of the tie rod 42 and/or of the tie rod base 42a respectively a migration barrier for hydrocarbons of the fuel accommodated in the motorized vehicle tank 10, which shields the tank volume 18 with respect to the external environment U.

In the region of the cover section 50a, on its side that faces towards the joint plane FE, there is configured a tie rod part-structure 52 as a tie rod section 42b projecting from the tie rod base 42a towards the opposite tank wall region 27. The end face 52a of the tie rod part-structure 52 facing away from the recess 50 is configured and arranged for welding with an opposite to it end face 54a of a tie rod part-structure 54 of the tie rod bottom part 46.

Breaches 56 in the tie rod part-structure 52 of the tie rod top part 44 allow pressure equalization between the tank volume 18 and the inner region 58 of the tie rod 42. In order to achieve the smallest possible weight, the tie rod part-structures 52 and 54 are internally hollow. Thus the breaches 56 also allow the interior space of the tie rod 42 to be used for storage of fluid, such that as a result of the configuration of the tie rod 42 essentially only the wall thickness of the tie rod part-structures 52 and 54 is lost as a storage volume in the tank volume 18. In addition, the breaches can serve as predetermined breaking points 57, for example in order to prevent, in the event of a vehicle collision, that the tie rod 42 undesirably opens the tank 10 destructively.

Resulting from the configuration of the tie rod top part 44 as adjoining and jutting out from the recess 50 of the barrier foil 16 that is provided by means of injection molding with the tank's inner wall 20, the tie rod top part 44 can be configured shorter and/or with a shorter projection length from the tank ceiling 26 respectively and/or with a lesser wall thickness and nonetheless demolded from the injection mold relatively simply, compared with a greater projection length of the tie rod top part 44. As a result, the tie rod top part 44 can be produced with high mechanical strength and complex geometry by means of injection molding, either in a separate injection or mounting step onto the tank's inner wall 20 or, and this is preferable, in one injection molding step with the injection of the tank's inner wall 20 onto the barrier foil 16.

In like manner as the tie rod 42 depicted in FIGS. 1 and 2, reinforcing ribs can also be produced by means of injection molding at the tank's inner wall 20 or at the tank's outer wall 22 with the thermoplastic synthetic injected externally or internally, viz. preferably at the same time as the injection of the respective wall 20 and/or 22 onto the barrier foil 16.

Instead of a recess 50, a bulge protruding away from the tank volume 18 can be produced in the same way from a tank shell 12 and/or 14. It can, if required, be opened at its protruding longitudinal end and then be configured as a connecting piece for connecting a fluid line.

When reshaping the barrier foil 16 to the recesses 50 and/or to bulges protruding in the opposite direction, undercut formations can be configured at the enveloping surfaces 50a, for instance with a wavy, zigzag, hacksaw, and/or Christmas tree contour, which provide for an even firmer anchoring of the tank part wall injected onto the enveloping surface.

FIG. 3 depicts a second embodiment of a motorized vehicle tank with a tie rod. Identical and functionally identical components and component sections as in the first embodiment are labelled in the second embodiment with the same reference labels, but increased numerically by 100. The second embodiment of the motorized vehicle tank and/or essentially of the tie rod respectively is described hereunder only in so far as it differs from the first embodiment of FIGS. 1 and 2, to whose elucidation otherwise reference is made also for elucidating the embodiment of FIG. 3.

The tie rod 142 of the second embodiment is roughly cylindrical, like the tie rod 42 of the first embodiment. In contrast to the first embodiment, the tie rod 142 exhibits no breaches, such that its inner region 158 is completely shielded from the tank volume 118 by the walls of the tie rod part-structures 152 and 154. This, however, is only depicted as an example. The tie rod 142 can also exhibit breaches in its wall, which connect its inner region 158 with the tank volume 118.

The tie rod 142 exhibits in the region of its longitudinal ends 144b and 146b of the tie rod top part 144 and/or of the tie rod bottom part 146 respectively that are close to the respective recesses 150, an encircling thin place in the material as a predetermined failure formation and/or predetermined breaking point 157, respectively. When a tensile load acting along the tie rod axis A exceeds quantitatively a predetermined failure threshold, the tie rod 142 tears at the predetermined breaking point 157, such that the tie rod cannot transmit loads exceeding the failure threshold between the tank wall sections 125 and 124 located opposite each other and connected by the tie rod 142, which otherwise, for example in the event of an accident to the vehicle carrying the tank 10, could result in undesirable opening of the tank 10.

The thin place in the material as a predetermined breaking point 157 is produced by sliders during the injection-molding production of the tie rod parts: tie rod top part 144 and tie rod bottom part 146.

The tie rod 142 exhibits at the longitudinal ends 144a and 146a facing towards one another of the tie rod top part 144 and/or of the tie rod bottom part 146 respectively an encircling widening, such that the end faces 152a and 154a exhibit a larger area than a cross-section of the tie rod 142 along a sectional plane orthogonal to the tie rod axis A between the widening and the predetermined breaking point 157. As a result, a tie rod 142 can be obtained with low weight and at the same time sufficiently high joint strength in the joint region 148 between the end faces 152a and 154a.

Naturally, the depicted widening with enlarged end faces can also be realized in another embodiment of a tie rod envisaged in the present application.

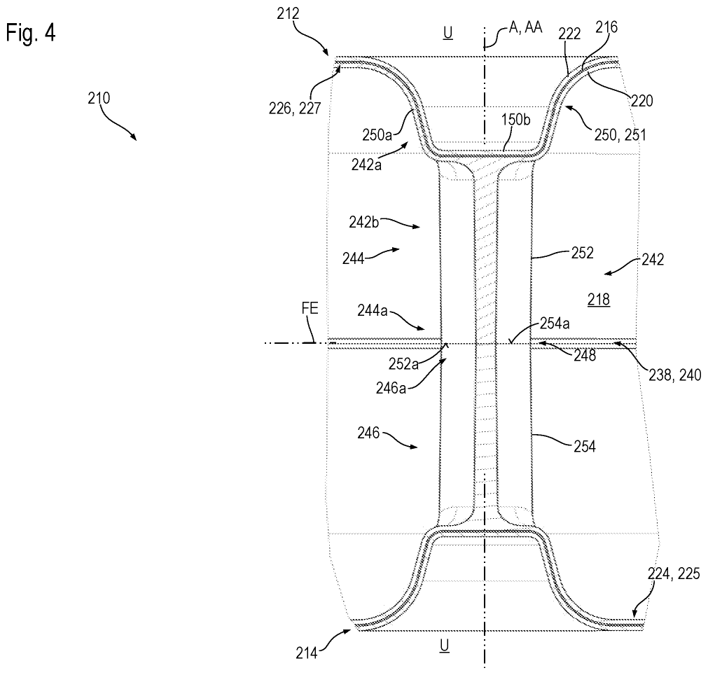

FIG. 4 depicts a third embodiment of a motorized vehicle tank with a tie rod. Identical and functionally identical components and component sections as in the first and second embodiment are labelled in the third embodiment with the same reference labels, but in the number range from 200 to 299. The third embodiment of the motorized vehicle tank and/or essentially of the tie rod respectively is described hereunder only in so far as it differs from the first two embodiments, to whose elucidation otherwise reference is made also for elucidating the embodiment of FIG. 4.

The tie rod 242 is not hollow and not rotation-symmetrical. It extends along the tie rod axis A with an essentially uniform cross-rib cross-section. As a cross-rib the tie rod 242 is especially rigid, in particular against bending. The volume loss sustained due to the configuration of the tie rod 242 in the tank volume 218 is very small. A predetermined breaking point is not configured in the depicted example. It can be configured for example in the region of the joint 248 of the two tie rod parts: tie rod top part 244 and tie rod bottom part 246. One option for configuring a predetermined breaking point at the tie rod 242 with a cross-rib cross-section consists in a tapered petering out of tie rod top part 244 and/or tie rod bottom part 246 in the relevant end face 252a or 254a, respectively.

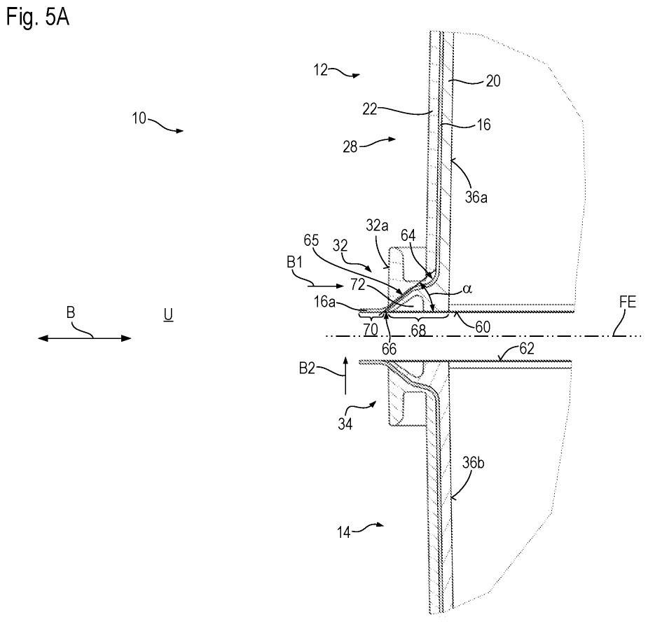

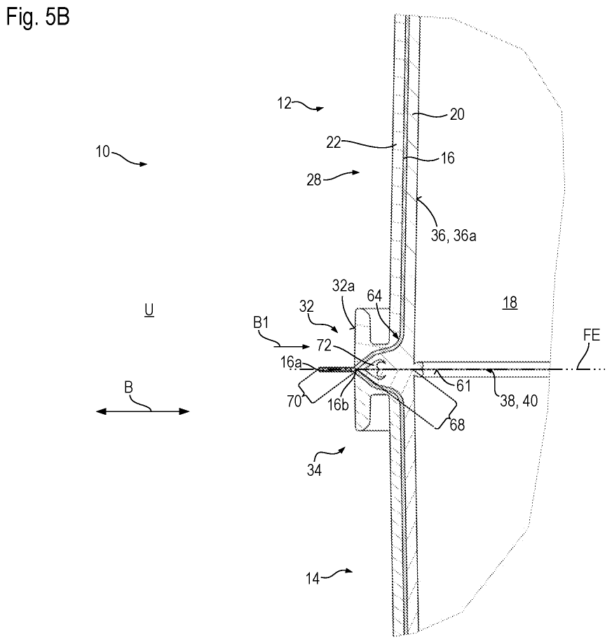

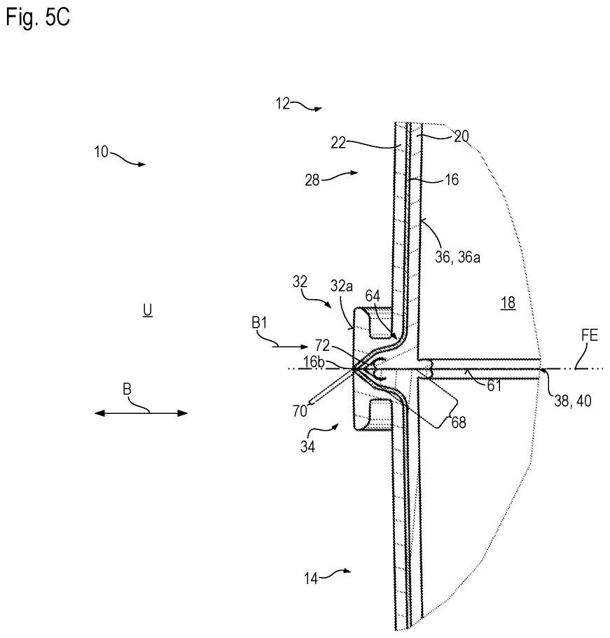

In FIG. 5A, which concerns the first embodiment, the joint flanges 32 and 34 are depicted before their firm bonding. The joint flange 32 of the tank's top shell 12 exhibits on its side facing towards the joint flange 34 of the tank's bottom shell 14 an attachment surface 60, which during jointing comes into contact with the opposite attachment surface 62 of the joint flange 34.

In the depicted example, the injected tank's inner wall 20 in the region of the side wall section 28 and in the region of the tank ceiling 26 is about equally as thick as the injected tank's outer wall 22. This, however, need not be the case. For one thing, on one or on both sides of the barrier foil there can locally be no injection-molding material injected, consequently the tank's inner wall 20 and/or the tank's outer wall 22 can be locally recessed. For another, the tank's inner wall 20 can be configured locally thicker and/or thinner than the tank's outer wall 22 at the same location.

The barrier foil 16 follows in the region of the side wall section 28 the course of the internal side 36a of the tank's top shell 12, which after jointing forms the tank's internal side 36.

On approaching the attachment surface 60, however, the barrier foil 16 proceeds in the direction away from the tank volume 18 and towards the external environment U of the tank 10, viz. more strongly than the internal side 36 of the tank 10.

The barrier foil 16, preferably a multilayer arrangement made from a central EVOH layer, from adhesion-promoting layers made of LDPE applied to the EVOH layer on both sides, and in turn from external bonding layers made of HDPE applied to the adhesion-promoting layers made of LDPE, is itself advantageously made completely from a thermoplastic material and therefore thermally joinable. In the depicted example, the injected tank's inner wall 20 and the injected tank's outer wall 22 are made of HDPE or comprise HDPE.

As a result of the described course of the barrier foil 16 not only towards the attachment surface 60 but at the same time also away from the tank volume 18, for one thing the barrier foil 16 does not emerges obtusely from the attachment surface 60, but rather approaches it within an included angle α of for example approximately 40°. Thereby, on the one hand it arrives at the attachment surface 60 without kinks, and on the other, it reaches the attachment surface 60 so far away from the tank volume 18 that the barrier foil 16 is accessible in the region of the attachment surface 16 for further processing, in particular processing of the joint.

The barrier foil 16 is curved concavely in the region 64 when viewing the tank's top shell 12 along the viewing direction B1 from outside in the direction towards the tank volume 18, where the concavely curved region encircles the tank volume 18. The concavely curved region 64 can be followed by a section-wise flat tilted region 65.

The barrier foil 16 is moreover curved convexly in the region 66 when viewed along the viewing direction B2 from the tank's bottom shell 14.

The barrier foil 16 emerges from the joint flange 32 on an end face 32a of the joint flange 32 that faces away from the tank volume 18. During jointing, the two joint flanges 32 and 34 are made to approach each other through partial melting away of their attachment surfaces 60, such that the sections of the barrier foil 16 located outside the joint flanges 32 and 34 are also made to approach each other. A joint section 16a of the barrier foil 16 thus lies outside the joint flange 32, viz. radially outside the joint flange 32 relative to the tank volume 18. A further joint section 16b of the barrier foil 16, considerably shorter than the joint section 16a in the width direction B (see FIG. 5B), therefore lies inside the joined joint flanges 32 and 34.

Consequently, when joining the tank's top shell 12 with the tank's bottom shell 14, there is formed in the region of the joint flange 32 a first joint region 68 located radially further inside, i.e. nearer to the tank volume 18, in which solely material of the injected tank's inner wall 20 is joined, and there is formed a second joint region 70 in which the barrier foils 16 of the tank's top shell 12 and of the tank's bottom shell 14 are joined, where the second joint region 70 is located further away from the tank volume 18 than the first joint region 68. Consequently the second joint region 70 shields the first joint region 68 with respect to the external environment U of the tank 10 and the first joint region 68 shields the second joint region 70 with respect to the tank volume 18.

Due to an encircling hollow 72 in the region of the attachment surface 60, the first joint region 68 is configured in two parts with a wider part lying nearer to the tank volume 18 and with a narrower part lying further away from the tank volume 18. The hollow 72 proceeds in the width direction of the attachment surface 60 between the said parts of the first joint region 68.

FIG. 5B shows the two tank shells 12 and 14 of FIG. 5A after they were joined to the tank 10. The first joint region 68 and the second joint region 70 are produced.

Merely for the sake of improved clarity, these two joint regions 68 and 70 are labeled obliquely outside the joined joint flanges 32 and 34. As a result of the joining, the attachment surfaces 60 of the two tank shells 12 and 14 have now become a common joint area 61.

The welding bead 38 in the first joint region 68 was formed both into the tank volume 18 and into the hollow 72, such that the material of the tank's inner wall 20 displaced during welding does not interfere with the second joint region 70. Since the remote part of the first joint region 68 located further away from the tank volume 18, beyond the hollow 72, exhibits only a relatively small joint area, only a small amount of material is displaced here.

The barrier foil 16, which emerges at the end faces 32a and 34a of the relevant joint flanges 32 and 34 respectively, separates the tank's inner wall 20 physically from the tank's outer wall 22, such that the outer tank walls 22 of the two tank shells 12 and 14 are connected in the region of the joint flanges 32 and 34 only indirectly via the barrier foil 16 and the inner tank walls 20, but not directly with each other.

FIG. 5C shows further processing of the tank 10 of FIG. 5B, after the part of the barrier foil 16 projecting beyond the end faces 32a and 34a outward to the external environment U, i.e. the joint section 16a located outside the joint flanges 32 and 34, was cut off flush with the end faces 32a and 34a. There remains at the tank 10 only the short joint section 16b, in the width direction B, located inside the joint flanges 32 and 34.

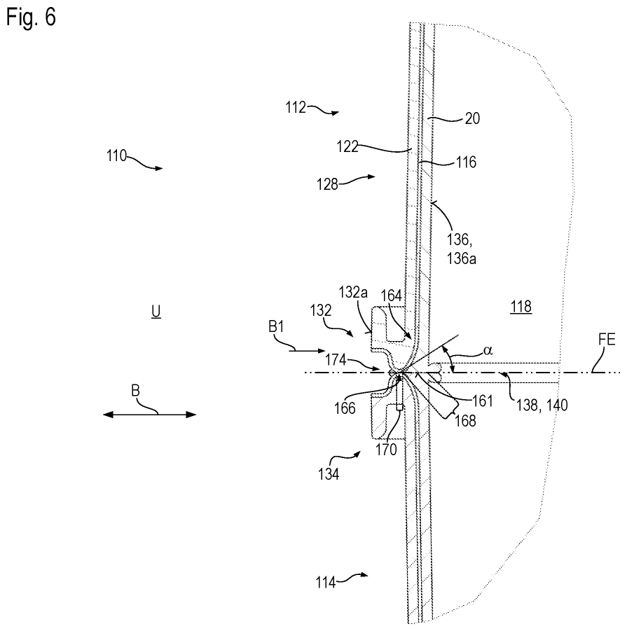

FIG. 6 depicts again the second embodiment of a motorized vehicle tank of the present invention, but this time only in connection with the joining situation at the joint flanges. Identical and functionally identical components and component sections as in the first embodiment of FIGS. 1 to 4 are labelled in FIG. 6 with the same reference labels, but increased numerically by 100. The second embodiment of FIG. 6 is elucidated only in so far as it differs from the first embodiment of FIGS. 1, 2, and 5A to 5C, to whose elucidation otherwise reference is made also for describing the second embodiment of FIG. 6.

We point out further that the configuration of a particular tie rod in the motorized vehicle tank is independent of the configuration of a joint connection at the joint flanges.

In the embodiment of FIG. 6, section 164 of the barrier foil 116, concave from the direction of view B1, which has the effect that the barrier foil 116 moves away from the tank volume 18 without kinks when approaching the joint flange 132, transitions into section 166, convex from the direction of view B1, which forms that section of the attachment surface 60 which forms the second joint region 170.

In the second joint region 170 the barrier foil 116 is configured as U-shaped in longitudinal section, i.e. trough-shaped, such that the barrier foil 116 proceeds on both sides of the joint region 170 away from the joint area 61 and from the joint plane FE, respectively. Once again, the outer tank walls 122 are not connected directly with each other.

At the section of the joint flanges 132 and 134 that is located radially outside, i.e. further away from the tank volume 118 than the second joint region 170, there is formed an at least in part, preferably completely, encircling trough 174, which can be used as a handle strip or for the engagement of a manipulation or transportation tool for the manipulation and/or for the transportation respectively of the motorized vehicle tank 10.

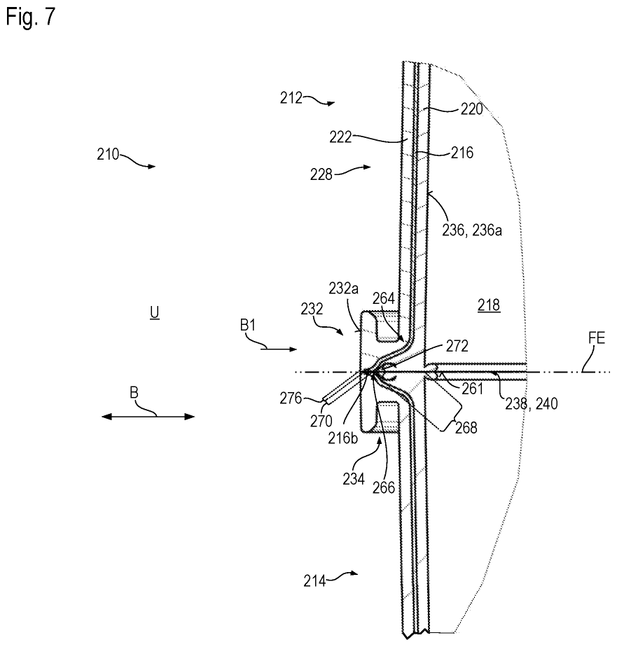

FIG. 7 depicts again the third embodiment of a motorized vehicle tank of the present invention, once again only in connection with the joining situation at the joint flanges. Identical and functionally identical components and component sections as in the first and the second embodiment of FIGS. 1, 2, and 5A to 6 are labelled in FIG. 7 with the same reference labels, but in the number range 200 to 299. The third embodiment of FIG. 7 is elucidated only in so far as it differs from the first and the second embodiment of FIGS. 1, 2, and 5A to 6, to whose elucidation otherwise reference is made also for describing the third embodiment of FIG. 7.

The third embodiment of FIG. 7 corresponds essentially to the second embodiment of FIG. 5C, with the difference that the outer wall sections 222 are configured to extend at the joint flanges 232 and 234 radially outwards towards the external environment so far that on joining together the tank shells 212 and 214 they form a third joint region 276, which is further away from the tank volume 218 than the second joint region 270 of the barrier foil 216. The third joint region 276 thus shields the second joint region 270 with respect to the external environment U and the first joint region 268 as before shields the second joint region 270 down towards the tank volume 118.

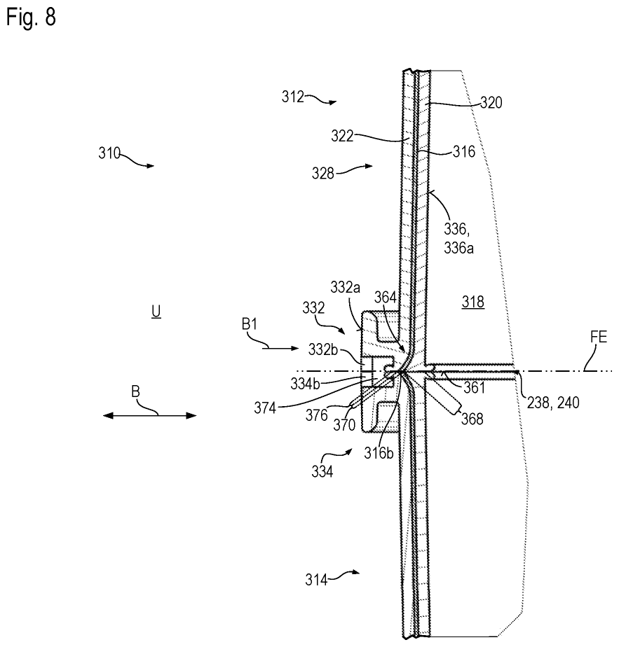

FIG. 8 depicts a fourth embodiment of a motorized vehicle tank of the present invention, once again, only in connection with the jointing situation at the joint flanges. Identical and functionally identical components and component sections as in the first to third embodiment of FIGS. 1, 2, and 5A to 7 are labelled in FIG. 8 with the same reference labels, but in the number range 300 to 399. The fourth embodiment of FIG. 8 is elucidated only in so far as it differs from the first to third embodiment of FIGS. 1, 2, and 5A to 7, to whose elucidation otherwise reference is made also for describing the fourth embodiment of FIG. 8.

The fourth embodiment shows, like the third embodiment, a third joint region 376 shielding the second joint region 370 outwards towards the external environment U. The joint flanges 332 and 334 project relative to the third joint region 376 outwards towards the external environment U and form a cutout 374, as is already known similarly from the second embodiment.

The joint flanges 332 and 334 can exhibit at their end faces 332a and 334a bridges 332b and 334b respectively proceeding towards each other, which in FIG. 8 are indicated only by dotted lines. The bridges 332b and 334b can be welded with each other at their attachment surface sections facing towards each other, such that the cutout 374 forms a closed-off volume, in particular a closed volume encircling the tank 10.

The third joint region 376 is then configured in two parts with a region lying radially inside the cutout 374 and with a region located radially outside the cutout 374, formed by the joint area of the bridges 332b and 334b.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-15. (canceled)

16. A motorized vehicle tank, comprising a first tank shell and a second tank shell, where the first tank shell and the second tank shell between them define at least one section of a tank volume of the motorized vehicle tank, where the first tank shell and the second tank shell are connected with each other, where at least one tank shell out of the first and the second tank shell is a multicomponent tank shell which exhibits a barrier foil and at least area-wise an inner wall section injected by injection-molding onto the internal side of the barrier foil facing towards the tank volume and/or an outer wall section injected by injection-molding onto the external side of the barrier foil facing away from the tank volume, wherein the motorized vehicle tank exhibits in at least one tank wall section formed by the multicomponent tank shell an eversion formed integrally at the barrier foil, which projects relative to the tank wall region surrounding it.

17. The motorized vehicle tank according to claim 16, wherein each of the two tank shells is a multicomponent tank shell.

18. The motorized vehicle tank according to claim 17, wherein the eversion exhibits on at least one side out of the internal side facing towards the tank volume and the external side facing away from the tank volume an injected wall section made of an injected inner wall section and an injected outer wall section.

19. The motorized vehicle tank according to claim 16, wherein the eversion exhibits on at least one side out of the internal side facing towards the tank volume and the external side facing away from the tank volume an injected wall section made of an injected inner wall section and an injected outer wall section.

20. The motorized vehicle tank according to claim 19, wherein the eversion exhibits the injected wall section at least on its convex side.

21. The motorized vehicle tank according to claim 20, wherein a functional formation, such as for example a mounting lug, a mounting projection, or a section of a tie rod is connected with the injected wall section.

22. The motorized vehicle tank according to claim 19, wherein a functional formation, such as for example a mounting lug, a mounting projection, or a section of a tie rod is connected with the injected wall section.

23. The motorized vehicle tank according to claim 22, wherein the motorized vehicle tank exhibits tank wall regions lying opposite to one another across the tank volume, which are connected physically with each other by means of at least one tie rod, where at least at one tank shell a tie rod base comprises an eversion as a recess on the tank's internal side projecting towards the tank volume, from which a tie rod section projects inside into the tank volume.

24. The motorized vehicle tank according to claim 23, wherein each of the tank shells as a tie rod base of one and the same tie rod exhibits a recess projecting towards the tank volume, from each of which a tie rod section projects inside into the tank volume, where the tie rod sections projecting from the two recesses are connected with each other in a tensile force-transmitting manner.

25. The motorized vehicle tank according to claim 24, wherein the tie rod sections projecting from the two recesses are connected with each other, in particular glued, welded, and/or clipped together at their end region located remotely from their respective recess.

26. The motorized vehicle tank according to claim 25, wherein at least one tie rod section exhibits one predetermined failure formation, which is configured to fail when a predetermined load exceeds a predetermined failure threshold.

27. The motorized vehicle tank according to claim 23, wherein at least one tie rod section exhibits one predetermined failure formation, which is configured to fail when a predetermined load exceeds a predetermined failure threshold.

28. The motorized vehicle tank according to claim 27, wherein the tie rod section is configured as hollow and exhibits at least one breach which penetrates through a wall of the tie rod section and which connects in a communicating manner a region of the tank volume located outside the tie rod section with a tie rod inner volume located inside the tie rod section.

29. The motorized vehicle tank according to claim 23, wherein the tie rod section is configured as hollow and exhibits at least one breach which penetrates through a wall of the tie rod section and which connects in a communicating manner a region of the tank volume located outside the tie rod section with a tie rod inner volume located inside the tie rod section.

30. The motorized vehicle tank according to claim 16, wherein the eversion is a bulge projecting on the tank's external side away from the tank volume.

31. The motorized vehicle tank according to claim 30, wherein the bulge is a connecting piece blank which is configured for the connection of a hose or pipe.

32. The motorized vehicle tank according to claim 16, wherein the eversion exhibits an enveloping surface section tilted relative to the tank wall region surrounding it.

33. The motorized vehicle tank according to claim 32, wherein the enveloping surface section projects along an eversion axis relative to the tank wall region surrounding the eversion and exhibits at least one rear-gripping profile.

34. The motorized vehicle tank according to claim 33, wherein the eversion exhibits a cover section spanning the enveloping surface section, where the enveloping surface section is located between the tank wall region surrounding the eversion and the cover section.

35. The motorized vehicle tank according to claim 32, wherein the eversion exhibits a cover section spanning the enveloping surface section, where the enveloping surface section is located between the tank wall region surrounding the eversion and the cover section.
